(19) United States
(12) Patent Application Publication
(10) Pub. No.: US 2016/0335641 A1
(43) Pub. Date: Nov. 17, 2016

(54) ENHANCED PAYMENT CARD PLATFORM

(71) Applicant: MasterCard International Incorporated, Purchase, NY (US)

(72) Inventors: Brigette White, Cortland Manor, NY (US); Theunis Johannes Gerber, Wildwood, MO (US); Julia Gosset, Tarrytown, NY (US)

(21) Appl. No.: 15/154,177

(22) Filed: May 13, 2016

Related U.S. Application Data
(60) Provisional application No. 62/160,768, filed on May 13, 2015.

(51) Int. Cl. G06Q 20/40; G06Q 20/34; G06Q 20/10

(52) U.S. Cl. CPC G06Q 20/4016; G06Q 20/10; G06Q 20/34

(57) ABSTRACT

Enhanced payment card account methods and systems. In an embodiment, a fraud scoring platform receives purchase transaction information and an associated decline decision generated by an issuer financial institution (FI) for a purchase transaction involving an enhanced payment card account. The fraud scoring platform then formulates a recommended decision score, determines that it is below a risk threshold, and transmits a purchase transaction authorization message to a payment network. Later, the fraud scoring platform receives a fraud message that the authorized purchase transaction of the enhanced payment card account is fraudulent, and then transmits instructions to transfer a monetary amount from a fraud expense pool to reimburse the issuer FI for costs associated with the fraudulent purchase transaction.

### CROSS REFERENCE TO RELATED APPLICATION

This patent application claims the benefit of U.S. Provisional Patent Application No. 62/160,768 filed on May 13, 2015, the contents of which are hereby incorporated by reference for all purposes.

### FIELD OF THE INVENTION

Embodiments disclosed herein relate to enhanced payment card account platform, methods, apparatus and systems. In particular, embodiments enable individual payment card account holders (or cardholders) to select payment card benefits from a list of compelling choices to obtain a personalized or customized payment card account. In addition, optimized payment card authorization and superior cardholder servicing across multiple touch points are described.

### BACKGROUND

Payment card systems are well known and are in widespread use. A prominent payment card system is operated by the assignee hereof, MasterCard International Incorporated, and by its member financial institutions. FIG. 1 is a block diagram of a conventional payment card system 100 that schematically illustrates a typical payment card transaction. In particular, to initiate the transaction, a customer may visit a retail store operated by a merchant, selects goods that he or she wishes to purchase, and presents his or her payment card to a merchant's Point Of Sale (“POS”) terminal or POS device 102. The POS device 102 reads the customer's payment card account number from the payment card (not shown), and transmits an authorization request to an acquirer platform 104 associated with a financial institution with which the merchant has a relationship. The authorization request typically includes data such as the payment card account number, the amount of the transaction and other relevant information, such as a merchant identifier and store location data. The authorization request message is routed via a payment system authorization platform or payment network 106 (which may be, for example, the well-known Banknet™ system operated by MasterCard International Incorporated) to an issuer platform 108 of the issuer financial institution that issued the customer's payment card.

Assuming that all is in order (for example, the issuer platform 108 determines that the cardholder's payment card account includes sufficient available credit to cover the amount of the purchase transaction), the issuer platform 108 transmits a favorable authorization response via the payment system authorization platform 106 to the acquirer platform 140 and on to the POS device 102. The transaction at the POS device 102 is then completed and the customer leaves the store with his or her merchandise. A subsequent clearing transaction initiated by the merchant results in a transfer of the transaction amount from the customer's payment card account to an account that belongs to the merchant. The customer's payment card account may be, for example, a debit card account, a credit card account, a prepaid card account, a loyalty card account, or the like. In the case of a debit card account, the clearing transaction results in the funds being debited directly from the cardholder's account. In the case of a credit card account, the clearing transaction results in a charge being posted against that credit card account, and the charge subsequently appears on the customer's monthly credit card statement.

The foregoing description of the typical transaction may be considered to be somewhat simplified in some respects. For example, a merchant processing system (not shown) may be interposed between the POS device 102 and the acquirer platform 104. Such a merchant processing system may be operated by or on behalf of the merchant to form part of the communications path between the acquirer platform 104 and a considerable number of POS terminals 102 operated by the merchant, which POS terminals may be, for example, in multiple store locations. It is also often the case, a third party transaction processing service (such as a Payment Services Provider (“PSP”)) may operate to handle payment card transactions on behalf of the acquirer and/or on behalf of a large number of other like financial institutions.

In addition to POS transactions, the payment card system 100 may be configured to process transactions associated with Automated Teller Machine

(“ATM”) withdrawals and/or Card Not Present (“CNP”) transactions, which may include online transactions, in a similar manner.

Issuer financial institutions (FIs), such as issuer banks, may offer premium payment card products to consumers that have a high credit limit (e.g., $25,000 U.S. or more) and that include various benefits, such as complimentary concierge services, access to exclusive airport lounges, free rental car upgrades, mileage points and/or rebates that may depend on the dollar amounts spent for particular types of goods and/or services, and the like. An issuer bank may only offer such premium payment card accounts to a group or class of consumers who can pass stringent consumer credit score requirements and/or net worth requirements. In addition, some issuer banks may charge consumers or cardholders an annual fee to carry and utilized such a premium payment card. Thus, issuer banks typically target high net worth individuals, also known as affluent consumers or wealthy consumers, for the premium payment card account offers. Such consumers can meet stringent credit score requirements and/or net worth requirements, and typically use their payment card accounts to spend more than an average payment card account holder. For example, an affluent consumer may use his or her premium payment card to purchase both high-cost luxury items and household necessities. Accordingly, issuer financial institutions (FIs), acquirer FIs, and operators of payment system authorization platforms have an interest in attracting or influencing such affluent or wealthy consumers to obtain such a premium payment card product.

In order to attract affluent consumers, issuers of credit card products typically confer one or more benefits or “perks” to their cardholders, as mentioned above. Issuer banks typically offer the same benefits or perks to all of the payment card account holders (or cardholders) of a particular type of payment card, which benefits are tracked at the bank identification number (“BIN”) level. In particular, payment card account benefits are assigned to a payment card type, which is typically identified by the 6-digit BIN or 9-digit BIN portion of the account number. For example, credit card holders that share the same 6-digit BIN may receive the same exact benefits regardless of whether or not a particular cardholder desires all of those benefits and/or intends to utilize one or more of the benefits. For example, an issuer FI may offer a “Platinum” payment card account that provides three benefits (for example, discounts on travel purchases, discounts on car rentals and extended warranty benefits), and those exact same three benefits are provided to each of their Platinum payment card account holders.

As mentioned above, premium credit card products typically include a substantial or high credit limit, which may be on the order of tens of thousands of dollars. Thus, a consumer who is a premium payment card account holder has an expectation that any purchase made with that premium payment card will be approved. However, a situation may arise wherein an affluent consumer provides his or her premium payment card to a merchant for a purchase transaction only to have the transaction declined. For example, an affluent cardholder may give a waiter his or her ABC Bank premium credit card to pay for a restaurant meal costing $675.00 for her family and friends, which cost is well within the credit limit, but have the payment card declined because the issuer bank's internal authorization system made a decision to decline the transaction (for example, it may be the case that the cardholder has not utilized her ABC Bank premium credit card account for several months, which caused the issuer bank's authorization system to flag the transaction as possibly fraudulent). In such a case, the payment card transaction is declined resulting in embarrassment for the affluent cardholder. This in turn may lead the affluent cardholder to avoid using, or minimize the use of, or stop using his or her ABC Bank premium payment card product for future purchases.

Accordingly, a need exists for enhanced payment card product platform methods and systems that enable an individual cardholder to customize or personalize an enhanced payment card product by selecting benefits from a compelling list of such benefits. The result is the cardholder obtaining an enhanced payment card account having benefits considered attractive and/or worthwhile to that individual cardholder. In addition, a need exists for enhanced payment card product platform methods and systems that provide optimized payment card account authorization (to minimize cardholder inconvenience and/or embarrassment), and that includes superior cardholder servicing across multiple touch points.

### BRIEF DESCRIPTION OF THE DRAWINGS

FIG. 1 is a simplified block diagram of a conventional payment card system;

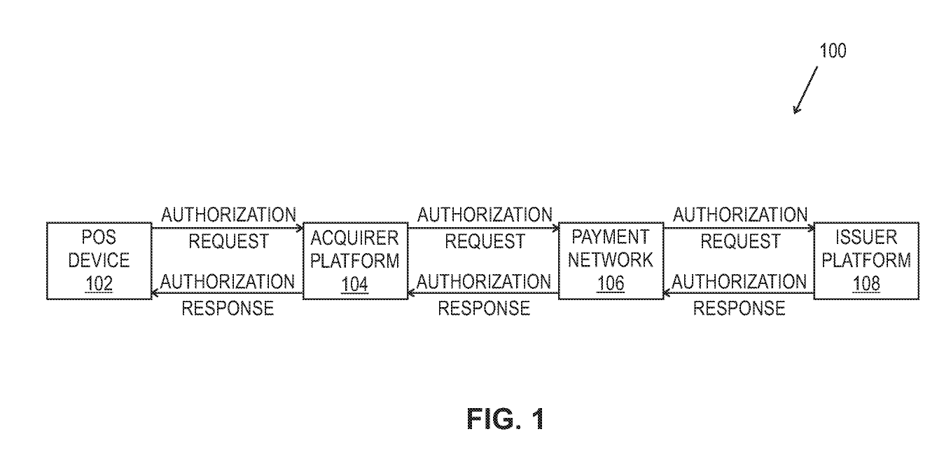

FIG. 2A is a block diagram of an embodiment of an account level benefits system according to the disclosure;

FIG. 2B illustrates an account level benefits (ALB) selection process according to some embodiments of the disclosure

FIG. 3 is a block diagram of an enhanced payment account transaction system according to some embodiments of the disclosure;

FIG. 4 is a block diagram of another enhanced payment card transaction system in accordance with some embodiments of the disclosure; and

FIG. 5 is a block diagram of an integrated enhanced payment card servicing platform in accordance with some embodiments of the disclosure.

### DETAILED DESCRIPTION

In general, and for the purpose of introducing concepts of embodiments of the disclosure, a “payment card” may be used to process transactions. As used herein, the phrase “payment card” or “payment card account” might refer to, for example, a financial account associated with a credit card, a debit card, a loyalty program card, a contactless card (such as an integrated circuit (IC) card), a badge, a license, a passport card, a radio frequency apparatus, a smartphone and/or a payment-enabled mobile device (for example, a tablet computer including payment circuitry).

Presented herein are embodiments of an enhanced payment card product platform, system and methods that enable an enhanced payment card account holder to select benefits from a list provided by a benefits provider. Thus, a cardholder can personalize or customize his or her enhanced payment card account with benefits and/or features that he or she desires to fit his or her lifestyle and/or life stage (for example, a life stage for a person or cardholder may encompass a phase of life wherein he or she is single, independent and working, or a phase of life as a parent of a young child, or a phase of life as an “empty nester,” which means a parent whose children no longer live at home, which may be after the children have graduated from college and are out on their own). It should be understood that the novel capabilities and/or processes described herein may be applicable to all payment types (for example, credit, debit, pre-paid, loyalty and/or gift cards) and across all consumer segments.

Embodiments of the enhanced payment card account platform, apparatus, methods and systems described herein also provide optimized payment card authorization processing for select transactions, and provide superior servicing to cardholders across multiple touch points (such as concierge services, mobile applications, website with actionable information and links, and easy to use claims handling). Implementations of the enhanced payment card account product may also include built-in fraud screening and/or fraud prevention features such as real time alerts, tokenization and/or provisioning of virtual card numbers (VCN) for E-commerce transactions, and white-glove or enhanced identity theft resolution and restoration services. In addition, some embodiments may include network level fraud detection solutions such as Decision Intelligence, the IQ Series of products, Expert Monitoring Services (EMS), Account Data Compromise (ADC) data and premium listings along with authentication risk best practices methods.

In some embodiments of the enhanced payment card platform methods, apparatus, and systems described herein an appropriate products and services fee structure is provided. The products and services fee structure may be utilized by the provider of the enhanced payment card platform (such as a payments processing entity like MasterCard International Incorporated) to cover the costs of goods, and/or servicing, and/or the fraud expense(s) that may be incurred by enhanced payment cardholders. Such a products and services fee may be charged to the benefits providers, such as the issuer financial institutions (FIs) that offer the enhanced payment card product. An issuer FI may in turn charge a portion or the entirety of such products and services fees to the cardholders (for example, an issuer FI may institute a dollar amount charge per account that may be due annually from each enhanced payment card account holder). In another scenario, the issuer FI may choose not to pass on the products and services fees to their enhanced payment card account holders and instead pick up those costs to entice high net worth consumers to open enhanced payment card accounts.

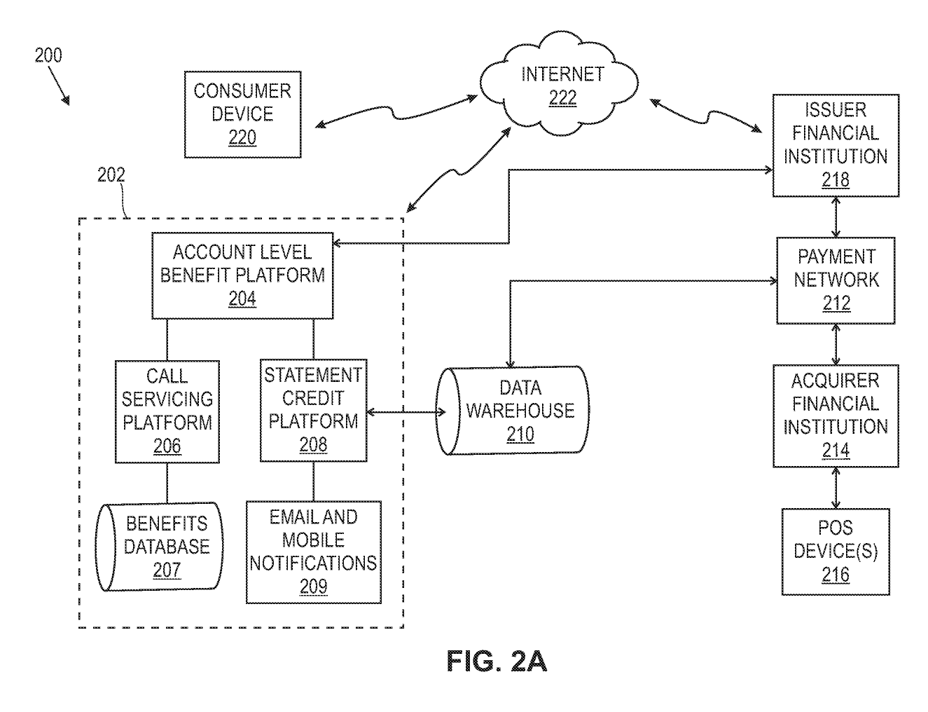

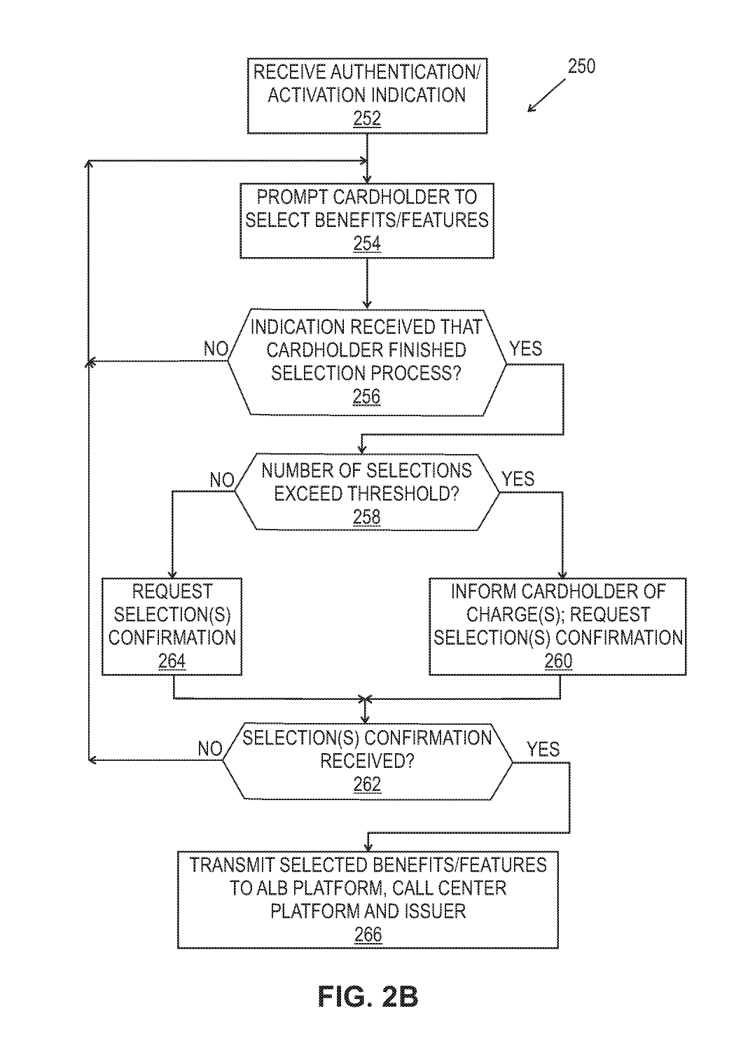

FIG. 2A is a block diagram of an embodiment of an account level benefits system 200 including components configured to operate in accordance with aspects of the processes described herein. It should be understood that the various components shown in FIG. 2A may be a subset of a larger account level benefits system that may be used to facilitate registration of cardholders to obtain enhanced payment card accounts, and/or to facilitate selection of cardholder benefits, and/or to facilitate provision of account-level benefits when appropriate.

The account level benefits system 200 includes an enhanced payment card account system 202. Also depicted is a consumer device or cardholder device 220 operable to communicate via the internet 222 with the enhanced payment card account system 202 and with an issuer financial institution (FI) 218. The issuer FI 218 is also operably connected to a payment network 212, and can communicate with an accounts level benefits platform 204 of the enhanced payment card account system 202. The payment network 212 is operably connected to an acquirer FI 214 and to a data warehouse 210, and the acquirer FI may be operably connected to one or more point of sale (POS) devices 216. Although the internet 222 is shown as interconnecting various components of the account level benefits system, other types of networks and/or network connections could be utilized.

Referring again to the enhanced payment card account system 202, in some embodiments the account level benefit platform 204 is operably connected to a call servicing platform 206 and to a statement credit platform 208. The call servicing platform 206 may be operably connected to a benefits database 207, and the statement credit platform 208 may be operably connected to an e-mail and mobile notifications engine 209 and to the data warehouse 210. In some embodiments, all or some of the components of the enhanced payment card account system 202 may be specialized electronic modules and/or electronic engines configured and/or designed to function in a manner consistent with the methods and/or processes disclosed herein. In some implementations, some or all of the components of the enhanced payment card account system 202 may be associated with, for example, a computer network or computer system that includes one or more computers, enterprise server(s), a server farm, and/or a database or other storage devices configured to function in a manner consistent with the methods and/or processes disclosed herein. In addition, the enhanced payment card account system 202 may, according to some embodiments, be operated by and/or associated with a payment card processing company, such as MasterCard International Incorporated. According to some embodiments, an “automated” enhanced payment card account subsystem 202 facilitates processing of enhanced payment card account benefits and/or services for cardholders. Thus, in some implementations the enhanced payment card account subsystem 202 is configured to automatically generate and/or transmit data and/or information in accordance with methods described herein. As used herein, the term “automatically” or “automated” may refer to, for example, actions that can be performed with little (or no) human intervention.

The issuer FI 218 may offer one or more enhanced payment card products to consumers via various well-known advertising platforms and/or methods. Such advertisements may inform consumers of enhanced payment card product features and/or consumer requirements for obtaining such an enhanced payment card product. For example, an enhanced payment card product may include foundational features and/or benefits that are provided to all enhanced payment card account holders, and may include optional and/or additional features and/or benefits that may be selected by the cardholder. For example, a particular issuer may offer foundational features or benefits that include cash back and fraud protection, and then offer a selection of additional features and/or benefits that the cardholder may choose from. It also should be understood that in some embodiments no foundational features and/or foundational benefits may be provided for the enhanced payment card account holders of a particular issuer, but in such cases cardholders are provided with a list of optional and/or additional features and/or benefits for selection.

As shown in FIG. 2A, a consumer may utilize his or her consumer device 220 (for example, a personal computer, a laptop computer, a tablet computer, a Smartphone, a personal digital assistant (PDA), a digital music player, and/or other electronic device) to connect via the internet 222 to the issuer FI 218 in order to apply for the enhanced payment card product. However, other methods for applying for a payment card account may also be utilized (for example, placing a telephone call to a customer service representative of the enhanced payment card issuer). If the consumer qualifies for the enhanced payment card account (for example, he or she meets the requirements set by the issuer of having a full-time job with a salary that meets or exceeds a threshold income level), after receiving all required consumer information, the issuer FI may mail or otherwise transmit an enhanced payment card (for example, a credit card, debit card, proximity payment card, and the like) to that consumer, with instructions regarding how to activate the enhanced payment card. For example, the activation instructions may include a request to call a toll-free activation telephone number (which may be an “800” number associated with the issuer) from the consumer's home telephone number, and/or activation instructions directing the consumer to navigate to a particular activation website and follow online instructions to activate the enhanced payment card account.

In some implementations, after the consumer has activated his or her enhanced payment card account, the issuer FI prompts the cardholder to select enhanced payment card account features and/or benefits to customize or personalize the enhanced payment card account. In some implementations, the consumer is directed to navigate to an accounts level benefits (ALB) website (not shown), which the cardholder can access with his or her consumer device 220 via the internet 222 or another network connection, and which may be hosted by the account level benefits platform 204. The ALB website may include a list of benefits and/or features offered by the benefits provider and/or enhanced cardholder account issuer. In some embodiments, a user interface (UI) (not shown) may be provided for use by the cardholder to facilitate the selection process, which UI may be provided by the issuer FI after the cardholder activates his or her enhanced payment card account. The UI may also be linked to the call servicing platform 206 and/or to the statement credit platform 208 (which identifies statement credit benefits). The ALB website may also include a link enabling the cardholder to contact an online customer service representative (CSR) to set up an online “chat,” wherein the CSR can help guide the cardholder to select the benefits that make the most sense. In addition, a toll-free telephone number (or other type of telephone number) may be provided to the cardholder so that he or she can talk to a CSR when deciding which benefits to associate with his or her enhanced payment card account. Use of the online “chat” and/or telephone discussion with a CSR options may aid the cardholder to determine which one(s) of the offered benefits would be most desirable to the cardholder. Once the cardholder has finished selecting one or more additional benefits and/or features, those selections may then be stored by the ALB platform 204 and/or the issuer financial institution 218.

FIG. 2B illustrates an account level benefits (ALB) selection process 250 according to some embodiments. It should be understood that the processes, methods, flows and/or flow charts described herein do not imply a fixed order of steps, and the disclosed embodiments may be practiced in any order that is practicable. In addition, it should be noted that any of the methods or processes described herein may be performed by hardware, software, or any combination of these approaches. For example, a non-transitory computer-readable storage medium may store instructions that when executed by a machine (such as a processor or computer) or electronic device or electronic module or engine results in performance according to any of the embodiments described herein. As mentioned above, some or all of the process steps may be “automated,” which refers to, for example, actions that can be performed with little or no human intervention.

Referring again to FIG. 2B, in some implementations, the ALB platform 204 receives 252 an authentication and/or activation indication from an issuer FI 218 that the consumer or cardholder has authenticated and/or activated his or her enhanced payment card account (which activation may be in accordance with a process described above). In some embodiments, the ALB platform may then prompt 254 the cardholder to select additional and/or optional features and/or benefits. In some other implementations, however, the issuer FI may provide the cardholder with a link to the ALB website (hosted by the ALB platform) or other contact information so that the cardholder can, for example, utilize a cardholder device to navigate to the ALB website and transmit a request to personalize his or her activated enhanced payment card account. In some cases the cardholder may be provided with a user interface (UI) (not shown) that may include information and/or directions regarding the benefits and/or selection process. For example, the UI may include an explanation informing the cardholder of a threshold number of additional and/or optional features and/or benefits that may be selected by the cardholder in accordance with his or her enhanced payment card account agreement without any additional charge(s) and/or fee(s). For example, in some implementations one or more foundational features and/or foundational benefits are provided to all enhanced payment card account holders of a particular issuer, and an individual cardholder is also permitted to select up to three additional and/or optional features and/or benefits at no extra charge or fee. Following this example, since the threshold number is three, an additional or extra charge may be imposed if the cardholder selects four or more optional features and/or benefits (i.e., selects more than the threshold amount of benefits and/or features). Any additional charge(s) or fee(s) may be dependent on the type of benefit and/or feature that is selected in addition to the threshold amount, and such charge(s) and/or fee(s) may be preset by the issuer FI and/or other benefits or features provider.

Referring again to FIG. 2B, if the ALB platform does not receive 256 an indication that the cardholder has finished selecting additional and/or optional features and/or benefits, for example, after a predetermined amount of time has elapsed, then the process branches back to step 254 wherein the cardholder is again prompted to make a selection. Such processing may continue, for example, until either at least one selection is made by the cardholder or a threshold number of prompts have been transmitted to the cardholder's device. In the case where the ALB platform receives 256 an indication that the cardholder has finished selecting additional and/or optional features and/or benefits, then the ALB platform determines 258 if the number of selected features and/or benefits exceeds the predetermined threshold. If so, then the cardholder is informed 260 of any extra charge(s) that may be required, and a confirmation response is requested from the cardholder regarding the selected benefits and/or features. If a selection(s) confirmation is not received in step 262 (which may mean that the cardholder does not agree to pay any additional charges), then the process branches back to step 254 wherein the cardholder is again prompted to select additional and/or optional features and/or benefits. In some embodiments, the cardholder may instead have the option to provide a decline message in which case the process again branches back to step 254 and the cardholder is prompted again to select additional and/or optional features and/or benefits. In addition, in some implementations a time-out period (not shown) may also he utilized regarding receipt of the cardholder's confirmation, such that if the time-out period expires then the process branched back to step 254. However, if in step 262 the cardholder provides a confirmation message (which also indicates acceptance of the extra charges), then the ALB platform transmits 266 information concerning the additional and/or optional features and/or benefits selected by the cardholder to the issuer FI and the process ends 266. In this manner, the cardholder has personalized or customized his or her enhanced payment card account with the benefits and/or features that he or she values and/or will use.

Referring again to step 258 of FIG. 2B, if the ALB platform determines that the number of selections has not exceeded the predetermined threshold number, then the ALB platform requests 264 a confirmation response regarding the selected benefits and/or features. Again, if a selection(s) confirmation is not received before a predetermined time-out period expires, then the process branches back to step 254 wherein the cardholder is again prompted to select additional and/or optional features and/or benefits. However, if in step 262 the ALB platform receives a confirmation response, then the ALB platform transmits 264 information concerning the selected additional and/or optional features and/or benefits to the ALB platform, to the Call center platform, and to the issuer of the cardholder's enhanced payment account. The process then ends 266. Thus, the cardholder's enhanced payment card account has been personalized or customized in the manner desired by the cardholder with benefits and/or features that the cardholder values and/or will use.

It should be understood that, in some embodiments the cardholder may be permitted to access the ALB website at other times (in addition to immediately after authentication and/or activation of his or her enhanced payment card account) and be permitted to change and/or modify his or her selection of the additional and/or optional features and/or benefits in accordance with aspects of the process illustrated by FIG. 2B. In this manner, the cardholder may change or modify his or her enhanced payment card account as desired, for example, as the cardholder's financial and/or lifestyle and/or lifestage needs change.

It should also be understood that, in some embodiments the cardholder can access the ALB website during his or her payment card account renewal and be provided with recommendations for cardholder benefit selections. For example, a payment card processor, such as MasterCard International Incorporated, may operate the Account Level Benefits platform and may utilize and/or analyze spend data and benefit usage of a particular enhanced payment card account holder to determine what benefits would be optimal for that person. In particular, recommendations for benefit selections can be based on actual enhanced payment card account usage data and presented to the enhanced payment account holder during the benefit renewal period. Such recommendations may be presented to cardholders via the Call center, and/or via a website or webpage, and/or via a mobile application running on the enhanced payment card account holder's mobile device. In this manner, the enhanced payment card account holder may be apprised of any changes or modifications that he or she could make to the enhanced payment card account to obtain improved or increased benefits which, for example, fit the cardholder's financial and/or lifestyle and/or lifestage needs.

In some embodiments, the services and/or monetary benefits or features that comprise the foundational features and/or the additional or optional benefits and/or features selected by the cardholder may be provided by an ALB platform operator (i.e., a third party such as a payment processing organization) instead of, or in addition to, the issuer FI. However, in some implementations the issuer FI may provide additional benefits that are supported by the ALB platform operator, and which are funded by the issuer FI or other third parties, i.e., merchants or manufacturers. Examples of foundational features (which may also be considered as “premium” features) that may be provided to each enhanced payment card account holder include, but are not limited to, ID Theft Resolution & Restoration services, a Dining Experiences package, credit card fraud alerts (which may be customizable by the cardholder), WiFi connectivity with a “WiFi Finder” Application, free 2-day shipping on internet purchases at select merchant websites, free return shipping for all U.S. merchants that accept FedEx, a Travel “Peace of Mind” insurance bundle, a discount car rental program, a luxury hotel and resorts prolzram, and a Shopping “Peace of Mind” insurance program. Optional or additional benefits or features that may be selected by the cardholder to customize and/or personalize his or her enhanced payment card account may include, but are not limited to, PGA Golf Tour tickets, a dining credit (for example, $50-$75 per year), : a travel credit (for example, $200 per year), a global entry or TSA Pre-Check credit, a Spa and/or Nightlife Experience, museum and/or city passes, cleaning and/or organizing services, an airport parking package, an airport lounge package, a travel medical package, and a virtual card number (VCN) (for security purposes when engaging in online shopping or recurring payments). Other optional and/or additional features and/or benefits may be added from time to time, and/or existing benefits and/or features removed over time as determined by a benefits provider and/or the enhanced payment account issuer.

As mentioned above, in some implementations the enhance payment card account holder may be permitted to select up to a predetermined threshold number of optional features to customize or personalize his or her enhanced payment card account, and the cardholder may be permitted to make changes to his or her benefits and/or features selections from time to time. For example, an issuer FI may allow the enhanced account holder to make changes to his or her benefits and/or enhanced payment card features on an annual basis, or quarterly, or monthly, or after a predetermined milestone has been achieved (such as a number of transactions that match or exceed a preset dollar amount). In addition, the cardholder may be permitted to add features and/or benefits that exceed the threshold number by paying an additional fee or fees.

After the cardholder has obtained the enhanced payment card account and selected his or her benefits, the cardholder may then use it to purchase goods or services from a merchant in a conventional manner. For example, with reference again to FIG. 2A, a cardholder may bring items to a merchant's POS device 216 in a retail store and present the enhanced payment card to purchase the items. The POS device 216 may then transmit purchase transaction data to the acquirer financial institution (FI) or acquirer platform 214, which then submits a purchase transaction authorization request to the payment network 212. The payment network 212 may identify the issuer FI 218 which issued the cardholder's enhanced payment card account, and then transmit the purchase transaction information to that issuer FI 218 for transaction approval. When the purchase transaction is approved, the payment network 212 may store purchase transaction data in the data warehouse 210. In some embodiments, the purchase transaction data in the data warehouse 210 may be accessed by the statement credit platform 208 in order to determine if any account level benefits should be provided to that particular cardholder.

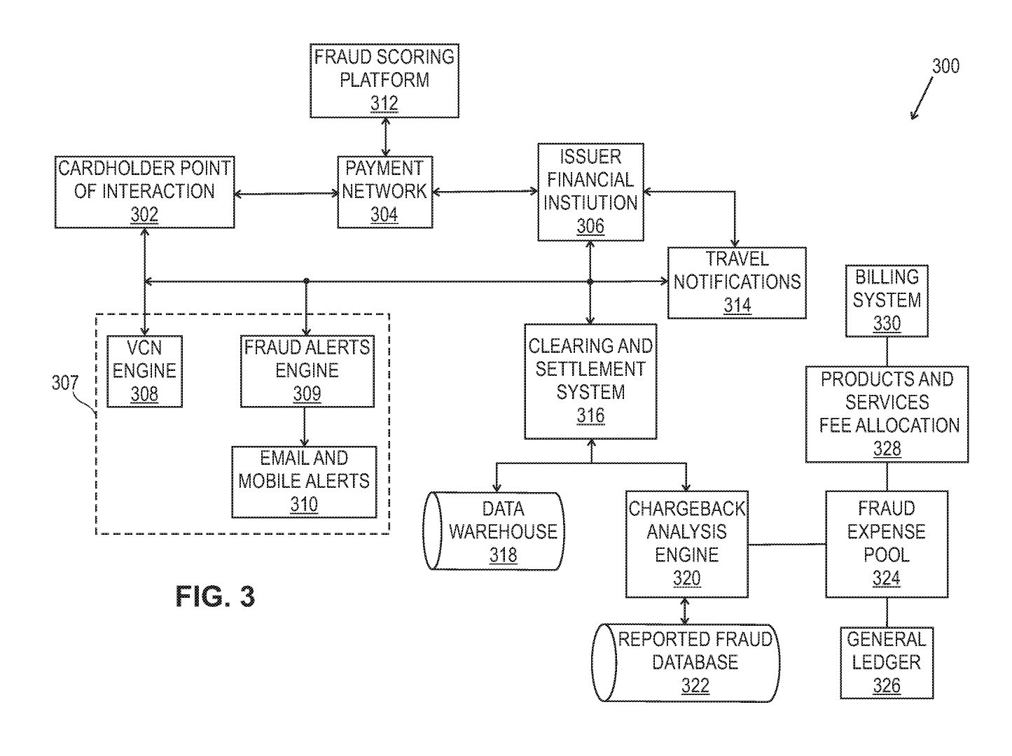

FIG. 3 is a block diagram of an enhanced payment account transaction system 300 according to some embodiments. A cardholder of an enhanced payment card account may conduct a purchase transaction with a point of interaction (POI) 302 (for example, at a POS terminal in a merchant store) and purchase transaction data is transmitted to a payment network 304 for transaction processing. Prior to the cardholder initiating a “card not present” (for example, a phone, E-commerce or online) transaction, the enhanced payment card account cardholder may first obtain a virtual card number (VCN) from VCN engine 308 of the In Control platform 307 to transmit along with the purchase transaction data to the payment network 304 (which VCN can be mapped to the PAN by the payment network).

In some embodiments, the In Control platform 307 may be owned and/or operated by the enhanced payment card account benefits provider, which may be a payments processing company or organization (such as MasterCard International Incorporated). In some embodiments of the In-Control platform 307, a fraud alerts engine 309 is also included for generating fraud alerts for the cardholder of the enhanced payment card account (wherein providing such fraud alerts may be an additional benefit and/or feature that has been selected by the cardholder). For example, a fraud alert may be generated by the fraud alert engine 309 when a particular purchase transaction includes data parameters that satisfy preset conditions that must be met in order to transmit such an alert. A cardholder may, for example, request an e-mail alert message and/or a mobile alert any time a purchase transaction totaling one thousand dollars ($1,000.00) or more is applied to his or her enhanced payment card account. Other conditions and/or criteria may also be included and/or apply. Thus, when one or more of such preset fraud conditions are met, the fraud alert notification engine 309 of the in-control platform 307 transmits an e-mail notification and/or a mobile alert to, for example, an electronic device and/or mobile device of the cardholder (in some implementations, the cardholder may have specified how he or she wishes to be contacted in association with purchases conducted with his or her enhanced payment card account). For example, the cardholder may receive an e-mail fraud alert (and/or a text message on his or her mobile device) indicating a possible fraudulent transaction involving his or her enhanced payment card which is based on conditions and/or criteria that has been pre-set by the cardholder. Cardholders may also pre-set blocks that prevent certain transactions from being authorized.

With reference again to FIG. 3, in some embodiments the payment network 304 receives the purchase transaction data and may determine, based on the primary account number (PAN) of the enhanced payment card, that one or more cardholder benefits and/or features may have been triggered. In addition, the payment network 304 determines which issuer financial institution (FI) of a plurality of issuer FIs (not shown) issued the enhanced payment card account. Thus, in some embodiments the payment network 304 forwards the purchase transaction data with a purchase transaction authorization request to the issuer FI 306 which issued the enhanced payment card account along with an indication regarding the potential triggering of one or more of the cardholder's enhanced payment account benefit(s) and/or feature(s). In some embodiments, the payment network 304 may also be configured to determine that a cardholder is traveling in a foreign country, and may also forward an indication that the cardholder is traveling in a foreign country to the issuer FI 306 so that the issuer FI does not decline the transaction based on their risk tolerance for foreign purchase transactions. Thus, in some embodiments, the issuer FI 306 communicates with a travel notifications engine 314 which is configured to determine when an enhanced payment card account holder is traveling in a foreign country, so that when a transaction occurs that originates from that country it will not be automatically declined.

As also shown in FIG. 3, the payment network 304 also communicates with a fraud scoring/decisioning platform 312, which may include components such as a fraud rules manager, a decision intelligence (DI) engine, an authentication intelligence engine, an Account Data Compromise system (ADC) component, and a fraud scoring algorithm (EMS) engine (not shown). In some implementations, the fraud scoring platform 312 evaluates transactions based on established spending patterns for each primary account number (PAN) and then determines whether a particular purchase transaction is likely legitimate or fraudulent.

The issuer FI 306 may also communicate with a clearing and settlement system 316, which is operably connected to a data warehouse 318 and to a fraud analysis engine 320. In some implementations, the fraud analysis engine 320 is operably connected to a reported fraud database 322, a fraud expense pool 324, a general ledger 326, a products and services fee allocation engine 328 and a billing system 330. The fraud expense pool 324 and/or general ledger 326 may include financial data associated with funds that have been allocated to the benefits provider to cover costs, for example, of fraudulent activity and/or benefits servicing and/or statement credits and/or benefits reimbursements associated with enhanced payment card accounts. For example, some of these components are utilized to cover the expense(s) associated with certain transactions (when appropriate, which will be explained below) so as to cover costs that would otherwise be charged to the issuer FI. For example, when one or more payment transactions prove to be fraudulent, the funds already collected from the issuer FIs (and/or collected from other entities, such as third party payment processor entities) via the products and services fees (and included in the fraud expense pool) can be utilized to cover the fraud costs.

As mentioned earlier, the transaction system 300 may be configured to automatically ensure that particular types of enhanced payment card account transactions are authorized (even if the issuer FI 306 may not authorize them or may initially generate a decline decision), to provide enhanced fraud monitoring or optimized authorization solutions, to provide enhanced benefits provisioning to a consumer's enhanced payment card account, and to facilitate clearing and settlement between one or more financial institutions (such as acquirer banks and issuer banks) in accordance with the systems and methods described herein. In particular, in some implementations optimized authorization processing is conducted, which includes transmitting the transaction data to the fraud scoring platform 312 to determine a fraud score or recommended decision score. The fraud score or recommended decision score may indicate the level of risk associated with the particular enhanced payment card account transaction, which may be determined by using one or more factors, including the previous transaction history of the cardholder, and data associated with his or her spending behaviors. For example, an enhanced payment card account holder may spend a certain amount of money each day at a local coffee shop, frequent several local restaurants on most Friday and/or Saturday nights and spend between fifty and one hundred dollars, and/or shop online at certain merchant websites and has a history of remitting payment to the issuer for such charges or expenditures. Thus, such merchant or merchant category level information and/or spending behavior data may be utilized by the fraud scoring platform 312 when calculating or formulating a recommended decision score for any particular transaction. In some implementations, a recommended decision score above a predetermined level or risk threshold may indicate that a particular purchase transaction should be declined. Thus, a recommended decision score below the predetermined risk threshold indicates that a particular purchase transaction for the enhanced card account holder could be authorized. In some implementations, an operator of a payment network (such as a payments processor) and/or the issuer FI sets the predetermined level or risk threshold (for use when considering the fraud score or recommended decision score), such that a recommended decision score above the risk threshold means that the transaction could be declined.

For example, a restaurant transaction for five hundred dollars ($500) or more for a particular enhanced payment card account cardholder may cause an increase in an overall fraud score or recommended decision score and could also include various other and/or additional risk factors that may increase or decrease the score. In one example, a merchant category code (“MCC”) or merchant identifier (“MID”) may also be utilized and/or taken into account when determining the fraud or recommended decision score (i.e., the MCC and/or MID could increase or decrease a fraud score or recommended decision score depending on context and/or other factors or criteria). In some implementations, a MCC and/or a MID may encompass a numeric code created by a payments processing company, such as MasterCard® or VISA®, and assigned to a business or business group by an acquirer FI when the business first starts accepting payment cards as a form of payment. The MCC and/or MID may be used to classify the business by the type of goods or services it provides. For example, in the United States, the MCC can be used to determine if a payment needs to be reported to the IRS for tax purposes. In addition, MCCs may be used by payment card issuer FIs to categorize, track and/or restrict certain types of purchases.

In some implementations, a business classification and/or the MCC and/or the MID might be used to apply different business rules and/or logic decisions to the recommended decision score for enhanced payment card account transactions. For example, if the MCC indicates that the transaction is from “Sam's Restaurant,” which the cardholder of the enhanced payment card account frequents on a regular basis, then the recommended decision score may be improved somewhat by applying a value to decrease the overall score (even if the purchase transaction amount is a high dollar value) to ensure that this particular transaction of the enhanced payment card account cardholder is not declined (because it seems to be for a legitimate purchase). Such a decision serves to avoid consumer inconvenience and/or embarrassment, and promotes the utilization of the enhanced payment card account by the cardholder.

However, in another example, if the MCC indicates that the transaction originated from an upscale designer handbag merchant or a jewelry store merchant that the enhanced payment card account cardholder has never before frequented, then (in implementations wherein a high recommended decision score indicates increased risk of fraud) the recommended decision score may be increased by a certain amount and/or a predetermined algorithm may be used to increase the recommended decision score. In this example, the recommended decision score may be increased further still if the total purchase transaction exceeds a preset threshold value (which may have been set by the issuer FI) such as two thousand dollars ($2,000.00). The result may be a decline recommendation by the fraud scoring platform 312 if the recommended decision score equals or surpasses the risk threshold that had been determined for the enhanced payment card account. In addition, in some implementations, the issuer FI may specify that any purchase transactions of the enhanced payment card account holder having a total transaction amount equal to or less than a threshold purchase amount be automatically authorized regardless of other factors, such as the MCC. For example, all purchases having a value of twenty dollars ($20) or less for the enhanced payment card account holder are automatically authorized as long as the cardholder is in good standing (i.e., had adequate credit line value available).

Thus, optimization or optimized authorizations for cardholders having enhanced payment card accounts may be determined or formulated by the fraud scoring platform 312 based on various considerations, such as the total dollar amount of a particular purchase transaction, and the MCC and/or the MID in combination with additional information (such as cardholder purchase transaction history data and the like). In some embodiments, the fraud scoring platform 312 via the payment network 304 thus makes a transaction authorization recommendation by providing a recommended decision score to the issuer FI 306 for certain purchase transactions involving an enhanced payment card account cardholder in order to prevent a transaction decline that would create inconvenience and/or embarrassment for that cardholder. In particular, the issuer FI computer 304 may generate a transaction decline decision based on limited data but the fraud scoring platform may formulate a recommended decision score indicating that the transaction should be authorized based on data and/or information and/or use of a fraud algorithm that is/are not utilized and/or not available to the issuer FI computer. In some other embodiments, the fraud scoring platform 312, based on a recommended decision score that is below the risk threshold, transmits a purchase transaction authorization message to the payment network 304 on behalf of the issuer FI 306, thus authorizing the purchase transaction based on the recommended decision score for the benefit of the enhanced payment card account cardholder. In some implementations, the fraud scoring platform also transmits a copy of the purchase transaction authorization message to the issuer FI computer 306 via the payment network 304 as notification of the authorization decision.

In some embodiments, the transaction data of enhanced payment card accounts may be provided to the automatic travel notifications engine 314 to determine whether or not a foreign or cross-border transaction is legitimate. For example, consumer device GPS data (if available) may indicate that the cardholder is in a foreign country, and/or the cardholder's purchase history data (for example, a recent purchase by the cardholder of airline tickets) may be analyzed and/or utilized to determine if there is a high probability that the enhanced payment card account cardholder is traveling in a foreign country and therefore a foreign transaction is legitimate. Other data which may be available to the accounts level benefits (ALB) platform, such as social media data of the cardholder, may also be used in order to make a determination that a cardholder is currently in a foreign country so that the enhanced card account can be used. Thus, authorizations may further be optimized by the travel notifications engine 314 providing the issuer FI 306 with automated travel notifications when it is apparent that an enhanced payment card account cardholder is legitimately in a foreign country. The issuer FI 306 can then determine whether or not to authorize a particular foreign purchase transaction, and/or require another type or additional cardholder verification before providing a transaction authorization to mitigate the fraud risk (for example, requiring the foreign merchant to obtain biometric authentication data from the cardholder, such as a fingerprint and/or iris scan and/or photograph of the cardholder).

In some embodiments, as mentioned earlier fraud expense exposure of the enhanced payment card account system may be fully or partially covered by the fraud expense pool 324, which may be funded by a per card products and services fee charged to issuer FIs by the enhanced payment account benefits provider or benefits operator (such as a payment processing company like MasterCard International Incorporated). In addition, fraud exposure may be further mitigated through enhanced payment account cardholder directed tools that include setting real time transaction-triggered alerts via the fraud alerts engine 309 and email and mobile alerts component 310, and by a cardholder being able to obtain a virtual card number (VCN) from the VCN control engine 306 for “card not present” or online purchase transactions from, for example, merchant websites. Other tools may also be provided, such as tokenization and/or SecureCode™ tools that can be used by cardholders to increase the security of online (or Card Not Present (“CNP”)) transactions and/or in-person or Card Present) transactions.

In accordance with some embodiments, as mentioned above the enhanced payment card account benefits provider (such as MasterCard International Incorporated, which may also be the operator of the payment network 304) charges a products and services fee to all of the issuer FIs that are offering enhanced payment card accounts to consumers. The products and services fee may be set to an amount to cover the expenditures required to provide cardholders with all of the advantages and benefits of the enhanced payment card account product. In particular, the products and services fee may be at a level that factors in costs for operating and maintaining all components of the ALB platform and/or the enhanced payment card account system, as well as the costs to provide the benefits to the cardholders, to provide enhanced levels of customer service, to provide enhanced fraud monitoring and solutions, and to cover any amounts that must be paid (or paid back) to issuer FIs for any fraudulent activity that may occur. The products and services fee may be calculated by including factors such as how much margin is required and benefits usage.

A portion of the collected products and services fees may therefore be utilized and/or deposited by the enhanced payment card account benefits provider (for example, the operator of the payment network 304) in the fraud expense pool 324 to cover certain purchase transactions that were authorized by the fraud scoring platform 312 (and/or by the issuer FI computer 306) but later proved to be fraudulent. For example, if a purchase transaction involving an enhanced payment card account was authorized by the fraud scoring platform 312 (or if the issuer FI received a recommended fraud score indicating from the fraud scoring platform indicating that the purchase transaction should be authorized) and later it proves to have been a fraudulent transaction, then the payment network 304 and/or the issuer FI computer 306 may transmit a fraud message to the fraud scoring platform indicating that the authorized purchase transaction is fraudulent. In some implementations, the fraud scoring platform then determines, in accordance with an agreement reached between the issuer FI of the enhanced payment card account and the enhanced payment card benefits provider (which may be the operator of the payment network 304), whether or not all or a portion of the expenses and/or costs involved with that the fraudulent purchase transaction (identified by the fraud message) qualifies for reimbursement coverage. In some cases, full or partial reimbursement may be provided to the issuer FI from the fraud expense pool 324. The monetary amount of the reimbursement may depend upon, for example, the circumstances and/or the variables used by the fraud scoring platform 312 when the recommended decision score was formulated which led to the decision to authorize the fraudulent transaction. When a decision is made in favor of the issuer FI, then the fraud scoring platform transmits, via the payment network 304 and the issuer FI computer 306 to the clearing and settlement system 316, instructions to transfer a monetary amount from the fraud expense pool 324 to the issuer FI computer to reimburse as least some of the costs associated with the fraudulent purchase transaction. As mentioned above, the monetary amount may be a full or partial reimbursement of the costs associated with the fraudulent transaction. which in some implementations is based on an existing agreement between the issuer FI and the enhanced payment card account provider.

Potential mitigations to the amounts required to provide an enhanced premium payment card account to cardholders may include, but are not limited to, capping cardholder usage of certain key benefits, giving issuer FIs the option to “plus up” or improve benefits (which the issuer FIs would fund), and securing a re-insurer to cover all or a portion of the authentication risk (fraud risk). In particular, products and services fees (that may correspond to ongoing expenses that must be covered by the enhanced payment card processing subsystem 402) may include, but are not limited to, fraud risk expense exposure, features and/or benefits costs (which may include scale pricing), breakage for statement credits and benefits usage, expenses of leveraging payment network assets, expenses associated with leveraging fraud mitigation assets, and servicing support (for example, for concierge services, website maintenance, for development and maintenance of mobile applications, and cardholder claims handling). Other costs and/or service fees may also be required to be included in the products and services fee, and the products and services fee may be subject to change from time to time (for example, to increase on a periodic basis, which increase may depend on unexpected or increasing benefits costs and/or service fee increases). Thus, for any particular enhanced payment card account holder, the products and services fee may be set at a level to support the benefits and/or services selected by that cardholder and to support the level of servicing support provided by the issuer FI and/or the operator of the enhanced payment card account platform.

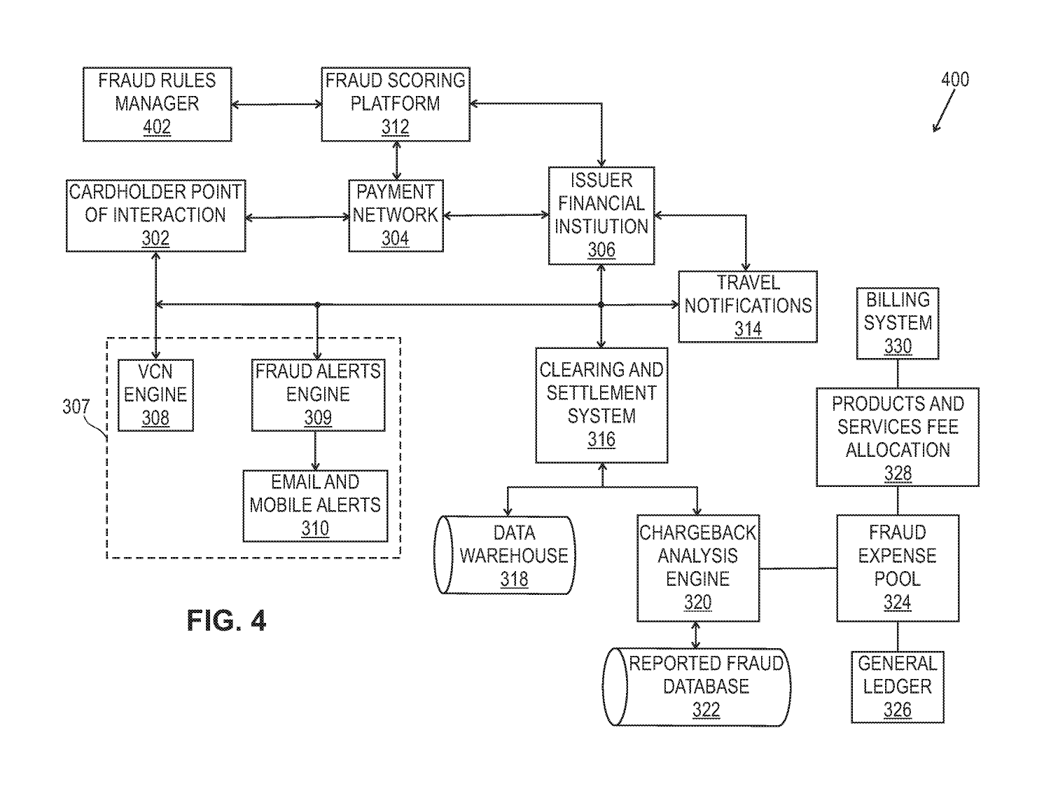

FIG. 4 is a block diagram of an enhanced payment card transaction system 400 in accordance with some embodiments. In particular, many of the same components shown in FIG. 3 are present in the transaction system of FIG. 4, however the payment transaction system 400 includes a fraud rules manager 402 operably connected to the fraud scoring platform 312. In addition, in this implementation, when a purchase transaction involving an enhanced payment card account is initially declined by the issuer FI 306, instead of transmitting that decline notification to the payment network 304, the issuer FI transmits it to the fraud scoring platform 312 for optimized authorization processing. The fraud scoring platform 312 applies algorithms and/or attributes to determine or formulate a recommended decision score which predicts or estimates the level of fraud risk associated with the purchase transaction involving an enhanced payment card account. Examples of transaction attributes and/or proprietary attributes include, but are not necessarily limited to, whether or not the enhanced payment card is an EMV-enabled (PIN and Sign) card, whether an EMS, Decision Intelligence and/or “Authorization IQ” score is within an approval threshold (wherein Decision Intelligence and “Authorization IQ” are systems promulgated by MasterCard International Incorporated that monitors the behavior of a consumer's payment card account over a rolling 36-month period and that can score payments using algorithms based on that very behavior), and whether the transaction is a “card present” or a “card not present” (CNP) transaction. Additional transaction attributes and/or proprietary attributes may include whether the transaction is with a select MCC (wherein MCCs may have fraud loss caps for each MCC or an overall fraud loss cap of $X for all select MCCs), whether the transaction is for less than a certain amount (i.e., ten dollars) regardless of MCC, whether or not select point of sale (POS) entry methods were used, whether a fraud status in SAFE with accurate reason codes is provided, and/or whether the transaction is not chargeback eligible regardless of amount. Numerous other attributes could also be utilized.

With reference to FIG. 4, in some implementations the fraud score or recommended decision score, the purchase transaction attributes, and the proprietary attributes are passed to the Fraud Rules Manager 402 which functions to adjust the recommended decision score. Thus, the recommended decision score factors in fraud risk as well as positive indicators of spend levels and/or expected behavior for the specific enhanced payment card account (for that cardholder). The attributes may represent different types of data and/or fraud rules, including previous transaction history data of the cardholder and/or spending data related to the cardholder's spending behaviors, and/or geographical factors, and/or merchant category codes (MCCs). The formulated recommended decision score is then transmitted to the issuer FI for further authorization processing. For example, in some embodiments the issuer FI receives the recommended decision score and then makes a decision as to whether to approve or authorize the transaction (and thus may overrule the issuer's own initial decline decision) when the received recommended decision score is below a predetermined fraud risk threshold, or to decide to uphold the decline decision when the received decision score is above the predetermined fraud risk threshold. Moreover, in some embodiments the issuer FI may receive raw data associated with the enhanced payment card account instead of, or in addition to, the recommended decision score. In this case, the issuer FI may utilize the raw data, with or without the recommended decision score, to determine whether or not to authorize the purchase transaction. The fraud risk threshold value may be determined through analysis of fraud trends, the expense associated with the fraud for a particular transaction, and/or the cardholder's profile or segment (for example, if the cardholder is a high wealth individual then the fraud risk threshold may be adjusted to permit or authorize a higher percentage of questionable or somewhat risky transactions in order to prevent inconveniencing the cardholder). In some embodiments, the issuer FI sets the fraud risk threshold for its own cardholders, while in other implementations the payments processor (for example, the operator of the payment network 304) sets the fraud risk threshold.

In some embodiments, the transaction authorization decision is executed or taken by the fraud scoring platform 312. In such a case, when the recommended decision score is above a predetermined threshold level (or fraud risk threshold) then another decline determination is made, and in this case the issuer FI's decline message will be transmitted to the payment network 304 and the enhanced payment card account transaction is declined. However, if a favorable decision score is generated by the fraud scoring platform 312 then the issuer FI's decline message may be overruled, and thus the fraud scoring platform 312 transmits an acceptance or authorization response to the payment network 304 on-behalf-of (OBO) the issuer FI. In some embodiments, such an OBO authorization is based on criteria agreed to by the issuer FI and/or the operator of the fraud scoring platform 312 and/or the payment processor. For example, a repeat transaction from a retailer store that the enhanced payment card account cardholder frequents on a regular basis may improve or reduce the recommended decision score enough to lower the fraud risk of the transaction to a level below the predetermined threshold. In this example, the fraud scoring platform 312 then issues a transaction authorization decision for this particular transaction of the cardholder (because it seems to be for a legitimate purchase). Such optimized. processing advantageously avoids consumer or cardholder inconvenience and/or embarrassment for enhanced payment card account holders.

However, if a particular transaction involving an enhanced payment card account was authorized by the fraud scoring platform 312 on-behalf-of the issuer FI 306, or that was authorized by the issuer FI 306 in dependence on a recommended fraud score provided by the fraud scoring platform, and it later proves to be a fraudulent transaction, then the issuer FI may be entitled to be reimbursed for all or a portion of the amount of the fraud from the fraud expense pool 324. In this case, the fraud scoring platform 312 may receive a fraud message indicating that the purchase transaction involving the enhanced payment card account is fraudulent from the issuer FI computer 306 and/or the payment network 304. The fraud scoring platform may then transmit, via the issuer financial institution, instructions to a clearing and settlement system 316 to transfer a monetary amount from the fraud expense pool 324 to the issuer FI computer 306 to reimburse costs associated with the fraudulent purchase transaction. In some implementations, the amount of money or percentage of costs that may be reimbursed due to the occurrence of a fraudulent transaction is based on an agreement reached by the enrolled or registered issuer FIs, the operator of the enhanced payment card platform, and/or the payment processor, which agreement may contain flexible terms that depend on, or that are based on, one or more of a multiplicity of variables and/or considerations.

In some embodiments, instead of formulating a recommended decision score for consideration by the issuer FI, the fraud scoring platform 312 transmits raw data regarding the enhanced payment card account holder's spending history, the current transaction, and other associated data to the issuer FI. In this case, the issuer FI then independently determines the authorization decision (a decline or an acceptance) by using the raw data to make the transaction decision as to whether or not to authorize the purchase transaction of the enhanced payment card account holder.

Optimized purchase transaction authorizations may therefore be determined based on various considerations such as the MCC in combination with additional information or data, such as cardholder purchase transaction history data, in order to prevent an issuer from declining a purchase transaction that would create inconvenience and/or embarrassment for an enhanced payment card account cardholder. In order to minimize the chances of a fraudulent transaction (and thus reduce the fraud expense exposure for the benefits provider), in some embodiments optimized authorizations are restricted to “card present” transactions (in contrast to “card not present” or online transactions). In addition, if such processing occurs to overrule the issuer FI's initial decline determination, and it is subsequently found that the initially declined transaction was indeed a fraudulent transaction, then in some embodiments the benefits provider and/or the operator of the fraud scoring platform may reimburse the issuer FI for some or all of the costs involved regarding the fraud. As mentioned above, such reimbursement funds may be provided from the fraud expense pool 324.

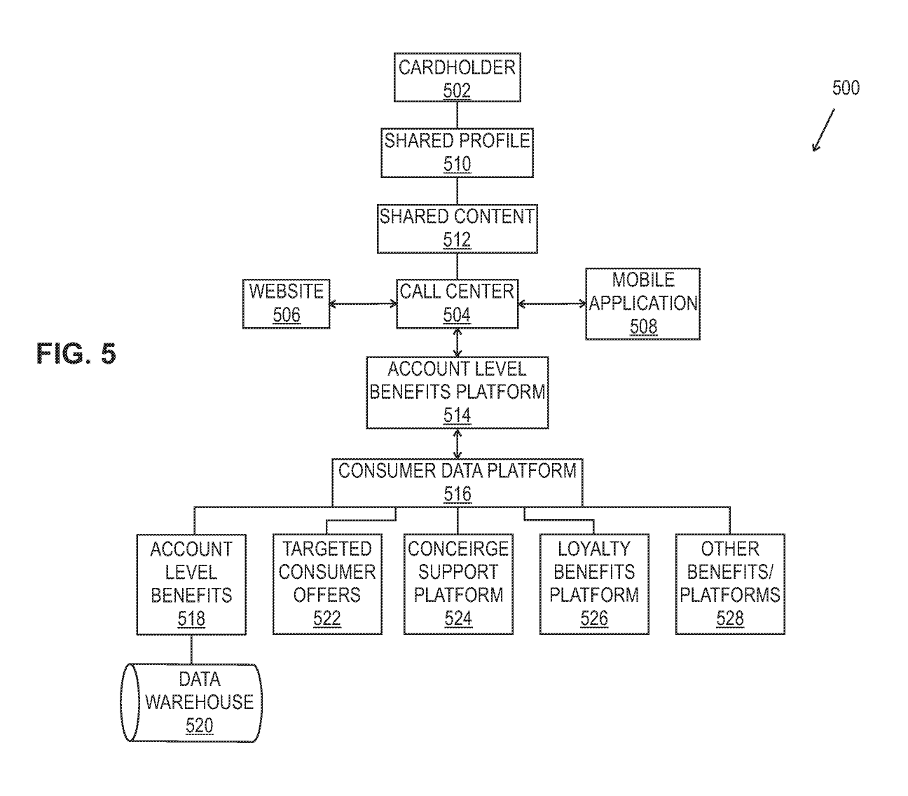

FIG. 5 is a block diagram of an enhanced payment card servicing platform 500 in accordance with the present disclosure. In some implementations, the servicing platform 500 enables cardholders to interact with the benefits provider to obtain benefits and/or conduct other business. For example, an enhanced payment card account holder or cardholder 502 may contact a call center 504 by telephone, or by utilizing a mobile application 508 (which may be loaded onto his or her mobile device, such as a smartphone) or by accessing a website 506, for example, via the internet (not shown). A trained customer service representative (CSR) of the call center 504 may be able to access and view a shared profile 510 of the cardholder and/or shared content 512 along with the cardholder 502. The CSR has access to the account level benefits platform 514 which is operably connected to a consumer data platform 516 that contains a multiplicity or plurality of content. Thus, the CSR can access the consumer data platform 516 to obtain information (or the cardholder can access information via the ALB website and/or the mobile application) associated with the cardholder's enhanced payment card account foundational benefits (if applicable), optional or additional (selectable) benefits, travel assets, offers, wallet information, receipt information, third party content (such as maps, weather information, WiFi finder, and the like), cardholder preferences data, claims status data, transactions data, fraud solutions information (such as virtual card number (VCN) data and/or information and fraud alerts data and/or other information), specialty package programs (such as a professional golfers association (PGA) package), and more. Various sub-platforms may be associated with the consumer data platform 516, such as an account level benefits (ALB) platform 518 and data warehouse 520 (which may be used to provide proactive benefits recommendations to cardholders), targeted consumer offers platform(s) 522 (which may be funded by merchants and provide targeted product or service offers), concierge support 524, loyalty benefits 526, and content associated with other benefits and/or platforms 528.

Accordingly, embodiments disclosed herein of enhanced payment card account platforms and/or systems and/or processes provide persons or consumers or cardholders with convenience and peace of mind. Because the disclosed systems and/or processes permit the enhanced payment card account cardholder to customize or personalized his or her enhanced payment card account, the enhanced payment card product simplifies the cardholders' life by reducing the thought process required to choose which of his or her payment card accounts to use for a transaction because, by definition, the enhanced payment card account is the best choice overall. The disclosed systems and/or processes also support lifestage changes by enabling cardholders to change benefits from time to time as their needs change rather than having to apply for different payment cards over time. In addition, the enhanced payment card account benefits services may be the same whether the cardholder uses a mobile application to conduct a purchase, or purchases goods or services from a merchant website, or utilizes his or her enhanced payment card in person at a merchant's retail store. The optimized authorization features of the enhanced payment card product also frees-up “mental real estate” of cardholders by providing an added sense of safety and/or assurance that particular types of payment or purchase transactions will likely be authorized. Cardholders appreciate that their enhanced payment card account permits them to obtain maximum returns without paying for benefits they do not use or value because they were permitted to personalize their accounts with benefits they value. In addition, a cardholder can be provided with an “earned” indulgence which may be deemed a personal treat (because that cardholder selected the personal benefits), or can be provided with a feeling of pampering one's self. Such an enhanced credit card product is also desirable for issuer FIs to offer because it provides an amplified sense of self or an emotional lift to the enhanced payment card account holders (due to special treatment), leading to a sense of grandeur or exclusivity, which may in turn lead to increased spending behavior and thus increased revenues for the issuer FIs and the payment processor (such as MasterCard International Incorporated). The enhanced payment card account system and/or service may also result in cardholder loyalty, meaning that enhanced payment card account holders would be more likely to retain their enhanced payment card for many years, which would also lead to increased revenue for both the issuer FI and the payment processor.

As used herein and in the appended claims, the terms “payment card system” and/or “payment network” refers to a system and/or network for handling purchase transactions and related transactions, which may be operated by a payment card system operator such as MasterCard International Incorporated, or a similar system. In some embodiments, the term “payment card system” may be limited to systems in which member financial institutions (such as banks) issue payment card accounts to individuals, businesses and/or other organizations.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. An enhanced payment card account method comprising:
receiving, by a fraud scoring platform from a payment network, purchase transaction information and an associated decline decision generated by an issuer financial institution (FI) computer for a purchase transaction involving an enhanced payment card account;
formulating, by the fraud scoring platform, a recommended decision score based on the purchase transaction information and purchase history data associated with the enhanced payment card account;
determining, by the fraud scoring platform, that the recommended decision score is below a risk threshold;
transmitting, by the fraud scoring platform to the payment network based on the recommended decision score, a purchase transaction authorization message;
receiving, by the fraud scoring platform from one of the payment network or the issuer FI computer, a fraud message indicating that the authorized purchase transaction involving the enhanced payment card account is fraudulent; and
transmitting, by the fraud scoring platform via the payment network and the issuer financial institution to a clearing and settlement system, instructions to transfer a monetary amount from a fraud expense pool to the issuer FI computer to reimburse costs associated with the fraudulent purchase transaction identified by the fraud message.

2. The method of claim 1, wherein transmitting the purchase transaction authorization message further comprises transmitting, by the fraud scoring platform, a copy of the purchase transaction authorization message via the payment network to the issuer FI computer to notify the issuer FI of the decision to overrule the decline decision.

3. The method of claim 1, further comprising:
collecting, by an operator of the payment network, products and services fees from each of a plurality of issuer FIs that issue enhanced payment card accounts; and
depositing, by the payment network via the clearing and settlement system, a portion of the collected products and services fees in a fraud expense pool.

4. The method of claim 3, wherein the products and services fee comprises a cost for each offered benefit, a servicing expense, a fraud expense and an expense to cover a value proposition for each issued enhanced payment card account.

5. The method of claim 1, wherein the recommended decision score is associated with at least one of a level of risk, attributes of the purchase transaction, and proprietary attributes.

6. The method of claim 1, wherein formulating the recommended decision score comprises applying, by the fraud scoring platform, at least one fraud algorithm.

7. The method of claim 6, further comprising applying at least one attribute to the fraud algorithm.

8. The method of claim 7, wherein the at least one attribute comprises at least one of cardholder spending data and merchant category codes (MCCs).

9. The method of claim 1, wherein formulating the recommended decision score further comprises utilizing at least one of positive indicators of spend levels and expected behavior for the enhanced payment card account.

10. The method of claim 1, further comprising, subsequent to formulating the recommended decision score:
determining, by the fraud scoring platform, that the recommended decision score is above the risk threshold; and
transmitting, by the fraud scoring platform, a purchase transaction decline message to the payment network on behalf of the issuer FI computer.

11. The method of claim 1, further comprising, prior to transmitting instructions to transfer a monetary amount from a fraud expense pool to the issuer FI computer, determining, by the fraud scoring platform, that the fraudulent purchase transaction qualified for reimbursement coverage in accordance with an agreement between the issuer FI of the enhanced payment card account and an enhanced payment card account benefits provider,

12. An enhanced payment card account system comprising:
a fraud scoring platform comprising at least one fraud scoring processor operably connected to a storage device;
a payment network operably connected to the fraud scoring platform;
an issuer financial institution (FI) computer operably connected to the payment network; and
a clearing and settlement system operably connected to the issuer FI computer and comprising a fraud expense pool;
wherein the storage device of the fraud scoring platform comprises instructions configured to cause the fraud scoring processor to:
receive purchase transaction information from the payment network for a purchase transaction involving an enhanced payment card account and an associated decline decision generated by the issuer FI computer;
formulate a recommended decision score based on the purchase transaction information and purchase history data associated with the enhanced payment card account;
determine that the recommended decision score is below a risk threshold;
transmit, based on the recommended decision score, a purchase transaction authorization message to the payment network;
receive, from one of the payment network or the issuer FI computer, a fraud message indicating that the authorized purchase transaction involving the enhanced payment card account is fraudulent; and
transmit via the payment network and the issuer financial institution to the clearing and settlement system, instructions to transfer a monetary amount from the fraud expense pool to the issuer FI computer to reimburse costs associated with the fraudulent purchase transaction identified by the fraud message.

13. The system of claim 12, wherein the instructions stored in the storage device of the fraud scoring platform for transmitting the purchase transaction authorization message further comprise instructions configured to cause the fraud scoring processor to transmit a copy of the purchase transaction authorization message via the payment network to the issuer FI computer to notify the issuer FI of the decision to overrule the decline decision.

14. The system of claim 12, further comprising instructions, subsequent to the instructions for formulating the recommended decision score, configured to cause the fraud scoring processor to:
determine that the recommended decision score is above the risk threshold; and
transmit a purchase transaction decline message to the payment network on behalf of the issuer FI computer.

15. The system of claim 12, further comprising, prior to the instructions for transmitting instructions to transfer a monetary amount from a fraud expense pool to the issuer FI computer, instructions configured to cause the fraud scoring processor to determine that the fraudulent purchase transaction qualified for reimbursement coverage in accordance with an agreement between the issuer FL of the enhanced payment card account and an enhanced payment card account benefits provider.

16. An enhanced payment card account method comprising:
receiving, by a fraud scoring platform, purchase transaction information and an associated decline decision from an issuer financial institution (FI) computer for a purchase transaction involving an enhanced payment card account;
formulating, by the fraud scoring platform, a recommended decision score based on the purchase transaction information and purchase history data associated with the enhanced payment card account;
transmitting, by the fraud scoring platform, at least one of the recommended decision score and raw data associated with the enhanced payment card account to the issuer FI computer;
receiving, by the fraud scoring platform, a purchase transaction authorization message associate with the purchase transaction involving the enhanced payment card account;
receiving, by the fraud scoring platform from at least one of the issuer FI computer and the payment network, a fraud message indicating that the purchase transaction involving the enhanced payment card account is fraudulent; and
transmitting, by the fraud scoring platform via the issuer financial institution to a clearing and settlement system, instructions to transfer a monetary amount from a fraud expense pool to the issuer FI computer to reimburse costs associated with the fraudulent purchase transaction identified by the fraud message.

17. The method of claim 16, further comprising:
collecting, by an operator of the payment network, products and services fees from each of a plurality of issuer FIs that issue enhanced payment card accounts; and
depositing, by the payment network via the clearing and settlement system, a portion of the collected products and services fees in the fraud expense pool.

18. The method of claim 17, wherein the products and services fee comprises a cost for each offered benefit, a servicing expense, a fraud expense and an expense to cover a value proposition for each issued enhanced payment card account.

19. The method of claim 16, wherein the recommended decision score is associated with at least one of a level of risk, attributes of the purchase transaction, and proprietary attributes.

20. The method of claim 16, wherein formulating the recommended decision score further comprises utilizing at least one of positive indicators of spend levels and expected behavior for the enhanced payment card account.

21. The method of claim 16, further comprising, subsequent to formulating the recommended decision score:
determining, by the fraud scoring platform, that the recommended decision score is above the risk threshold; and
transmitting, by the fraud scoring platform, a purchase transaction decline message to the payment network on behalf of the issuer FI computer.

22. The method of claim 16, further comprising, prior to transmitting instructions to transfer a monetary amount from a fraud expense pool to the issuer FI computer, determining, by the fraud scoring platform, that the fraudulent purchase transaction qualified for reimbursement coverage in accordance with an agreement between the issuer FI of the enhanced payment card account and an enhanced payment card account benefits provider.

23. An enhanced payment card account system comprising:
a fraud scoring platform comprising at least one fraud scoring processor operably connected to a storage device and a fraud rules manager;
a payment network operably connected to the fraud scoring platform;
an issuer financial institution (FI) computer operably connected to the fraud scoring platform and to the payment network; and
a clearing and settlement system operably connected to the issuer FI computer and comprising a fraud expense pool;
wherein the storage device of the fraud scoring platform comprises instructions configured to cause the fraud scoring processor to:
receive purchase transaction information and an associated decline decision from the issuer financial institution (FI) computer for a purchase transaction involving an enhanced payment card account;
formulate a recommended decision score based on the purchase transaction information and purchase history data associated with the enhanced payment card account;
transmit at least one of the recommended decision score and raw data associated with the enhanced payment card account to the issuer FI computer;
receive a purchase transaction authorization message associate with the purchase transaction involving the enhanced payment card account;
receive a fraud message from at least one of the issuer FI computer and the payment network, the fraud message indicating that the purchase transaction involving the enhanced payment card account is fraudulent; and
transmit, via the issuer financial institution to a clearing and settlement system, instructions to transfer a monetary amount from the fraud expense pool to the issuer FI computer to reimburse costs associated with the fraudulent purchase transaction identified by the fraud message.

24. The system of claim 23, further comprising instructions, subsequent to the instructions for formulating the recommended decision score, configured to cause the fraud scoring processor to:
determine that the recommended decision score is above the risk threshold; and
transmit a purchase transaction decline message to the payment network on behalf of the issuer FI computer.

25. The system of claim 23, further comprising, prior to the instructions for transmitting instructions to transfer a monetary amount from a fraud expense pool to the issuer FI computer, instructions configured to cause the fraud scoring processor to determine that the fraudulent purchase transaction qualified for reimbursement coverage in accordance with an agreement between the issuer FI of the enhanced payment card account and an enhanced payment card account benefits provider.
